(19) United States
(12) Patent Application Publication
(10) Pub. No.: US 2026/0080859 A1
(43) Pub. Date: Mar. 19, 2026

(54) VOICE PROCESSING SUPPORT DEVICE, VOICE PROCESSING SUPPORT METHOD, AND COMPUTER PROGRAM PRODUCT

(71) Applicants: KABUSHIKI KAISHA TOSHIBA, Kawasaki-shi (JP); TOSHIBA DIGITAL SOLUTIONS CORPORATION, Kawasaki-shi (JP)

(72) Inventor: Yoshinori KURATA, Moriya Ibaraki (JP)

(73) Assignees: KABUSHIKI KAISHA TOSHIBA, Kawasaki-shi (JP); TOSHIBA DIGITAL SOLUTIONS CORPORATION, Kawasaki-shi (JP)

(21) Appl. No.: 19/399,772

(22) Filed: Nov. 25, 2025

Related U.S. Application Data
(63) Continuation of application No. PCT/JP2024/030240, filed on Aug. 26, 2024.

(30) Foreign Application Priority Data
Sep. 1, 2023 (JP) 2023-142105

(51) Int. Cl. G10L 13/033; G06F 3/0484

(52) U.S. Cl. CPC G10L 13/033; G06F 3/0484

(57) ABSTRACT

According to an embodiment, a voice processing support device includes one or more hardware processors configured to: receive input of a parameter during reproduction of voice data to be edited, the parameter including at least a plurality of types of emotions different from each other and a mixing ratio of the plurality of types of emotions; and record the parameter whose input has been received, in association with a reproduction timing at which the input of the parameter has been received in the voice data.

### CROSS-REFERENCE TO RELATED APPLICATIONS

This application is based upon and claims the benefit of priority from Japanese Patent Application No. 2023-142105, filed on Sep. 1, 2023 and International Patent Application No. PCT/JP2024/030240 filed on Aug. 26, 2024; the entire contents of all of which are incorporated herein by reference.

### FIELD

Embodiments described herein relate generally to a voice processing support device, a voice processing support method, and a computer program product.

### BACKGROUND

A technique for synthesizing a voice having a voice quality different from that of an existing voice by mixing (morphing) voice data is known. For example, a technique for generating synthesized voice data by synthesizing a plurality of voice data on the basis of a predetermined morphing ratio is disclosed.

However, according to the related art, it is difficult to set a parameter related to transition of a time-varying emotion in detail although it is possible to set a parameter such as a morphing ratio for the entire voice data.

### BRIEF DESCRIPTION OF THE DRAWINGS

FIG. 1 is a diagram illustrating an example of a voice processing support device according to an embodiment;

FIG. 2 is a schematic diagram of an example of a display screen;

FIG. 3 is a schematic diagram of an example of a display screen;

FIG. 4 is a schematic diagram of an example of a display screen;

FIG. 5 is a schematic diagram of an example of a display screen;

FIG. 6 is a flowchart illustrating an example of a flow of information processing executed by the voice processing support device according to the present embodiment; and

FIG. 7 is a hardware configuration diagram.

### DETAILED DESCRIPTION

According to an embodiment, a voice processing support device includes one or more hardware processors configured to: receive input of a parameter during reproduction of voice data to be edited, the parameter including at least a plurality of types of emotions different from each other and a mixing ratio of the plurality of types of emotions; and record the parameter whose input has been received, in association with a reproduction timing at which the input of the parameter has been received in the voice data.

A voice processing support device, a voice processing support method, and a voice processing support program will be described in detail below with reference to the attached drawings.

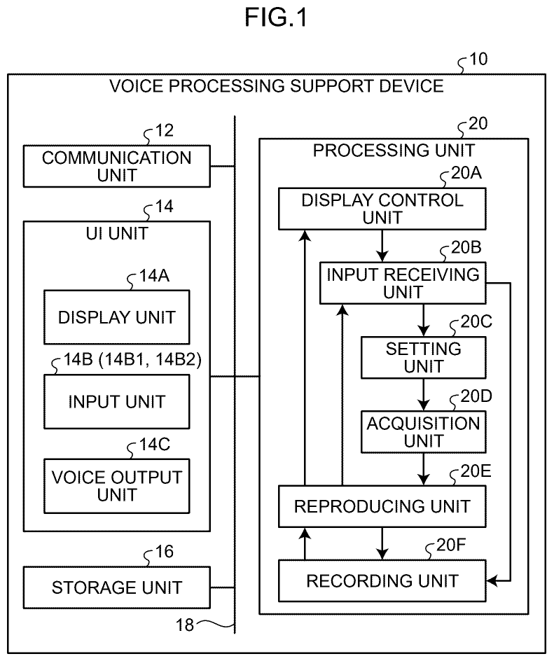

FIG. 1 is a diagram illustrating an example of a voice processing support device 10 according to the present embodiment.

The voice processing support device 10 is an information processing device that supports processing of voice data.

The voice processing support device 10 includes a communication unit 12, a user interface (UI) unit 14, a storage unit 16, and a processing unit 20. The communication unit 12, the UI unit 14, the storage unit 16, and the processing unit 20 are communicably connected via a bus 18.

The communication unit 12 communicates with another external information processing device over a network or the like. The UI unit 14 includes a display unit 14A and an input unit 14B.

The display unit 14A displays various kinds of information. The display unit 14A is, for example, a display such as a liquid crystal display (LCD) or an organic electro-luminescence (EL), a projection device, or the like.

The input unit 14B receives a user's operation. The input unit 14B is, for example, a pointing device such as a digital pen, a mouse, or a trackball, or an input device such as a keyboard. Note that at least a part of the display unit 14A and at least a part of the input unit 14B may be integral to constitute a touch panel. In the present embodiment, the input unit 14B includes a first operation unit 14B1 and a second operation unit 14B2.

The first operation unit 14B1 is an input device for inputting an operation direction and an operation amount. The first operation unit 14B1 is, for example, an input device capable of inputting an operation direction and an operation amount on the basis of an inclination direction and an inclination angle of a lever (stick). Such a first operation unit 14B1 is sometimes called a joystick. The first operation unit 14B1 may be, for example, a touch pad. In the present embodiment, an example in which the first operation unit 14B1 is a joystick will be described.

The second operation unit 14B2 is an input device for inputting an operation amount. The second operation unit 14B2 is, for example, a pedal-type or button-type input device pressed by a user's leg or the like. In the present embodiment, an example in which the second operation unit 14B2 is a pedal type input device for inputting an operation amount on the basis of pressing by a user's leg or the like will be described.

A voice output unit 14C is a speaker that outputs voice.

The storage unit 16 stores various data. The storage unit 16 is, for example, a random access memory (RAM), a semiconductor memory element such as a flash memory, a hard disk, an optical disk, or the like. Note that the storage unit 16 may be a storage device provided outside the voice processing support device 10. The storage unit 16 may be a storage medium. Specifically, the storage medium may store or temporarily store a program and various kinds of information downloaded via a local area network (LAN), the Internet, or the like. The storage unit 16 may include a plurality of storage media.

Next, the processing unit 20 will be described. The processing unit 20 executes various kinds of information processing. The processing unit 20 includes a display control unit 20A, an input receiving unit 20B, a setting unit 20C, an acquisition unit 20D, a reproducing unit 20E, and a recording unit 20F.

The display control unit 20A, the input receiving unit 20B, the setting unit 20C, the acquisition unit 20D, the reproducing unit 20E, and the recording unit 20F are, for example, realized by one or a plurality of processors. For example, each of the above units may be realized by causing a processor such as a central processing unit (CPU) to execute a program, that is, may be realized by software. Each of the above units may be realized by a processor such as a dedicated integrated circuit (IC), that is, may be realized by hardware. Each of the above units may be realized by using software and hardware in combination. In the case of using a plurality of processors, each processor may realize one of the units or may realize two or more of the units.

At least one of the above units and at least a part of the information stored in the storage unit 16 may be provided on a cloud server or the like that executes processing on a cloud.

The display control unit 20A displays various display screens on the UI unit 14. Details of the display screens will be described later.

The input receiving unit 20B receives a user's operation input on the UI unit 14.

For example, assume that the user desires to generate synthesized voice data using certain voice data.

Specifically, assume that the user desires to process and edit the voice data into synthesized voice data including a predetermined emotion with a predetermined emotion intensity along a time axis.

In this case, the user operates the input unit 14B to set voice dictionary data corresponding to the type of emotion used for setting the voice data. In the present embodiment, the input receiving unit 20B receives a user's input on a display screen displayed on the display unit 14A.

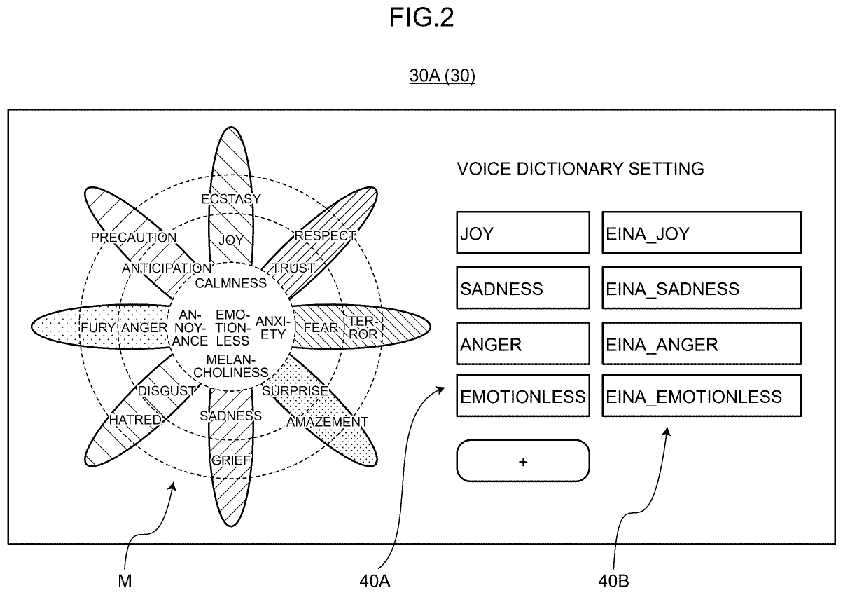

FIG. 2 is a schematic diagram of an example of a display screen 30A. The display screen 30A is an example of a display screen 30 displayed on the display unit 14A.

The display screen 30A includes an emotion map M, an emotion setting field 40A, and a voice dictionary data setting field 40B.

The emotion map M is a map expressing a correlation among a plurality of types of emotions. For example, the emotion map M is a diagram in which types of emotions are represented by colors and are three-dimensionally combined so that even a complex emotion such as mixture of emotions can be expressed. In the emotion map M, for example, regions of eight types of basic emotions, i.e., joy, trust, fear, surprise, sadness, disgust, anger, and anticipation, are arranged to extend radially in different directions around an emotionless region. Furthermore, in the emotion map M, regions of opposite types of emotions are arranged on opposite sides 180 degrees apart across the emotionless region arranged at the center. Furthermore, in the emotion map M, eight types of basic emotions are classified into three positive, negative, and neutral groups, and regions of types of emotions belonging to each group are mapped to be arranged at adjacent positions. Furthermore, among the regions of the types of emotions in the emotion map M, a region closer to the emotionless region arranged at the center represents a weaker emotion, and a region farther from the emotionless region represents a stronger emotion.

Note that the emotion map M may be any map expressing a correlation among a plurality of types of emotions, and is not limited to the form illustrated in FIG. 2.

The emotion setting field 40A is an input field for inputting a type of emotion used for setting voice data. For example, the user inputs, in the emotion setting field 40A, a type of emotion which the user wants to add to the voice data by operating the input unit 14B while viewing the emotion map M on the display screen 30A. Since the display screen 30A includes the emotion map M, the user can easily input the type of emotion in the emotion setting field 40A by viewing the emotion map M included in the display screen 30A.

The voice dictionary data setting field 40B is an input field for setting of voice dictionary data corresponding to the type of emotion input in the emotion setting field 40A.

The voice dictionary data is an acoustic model for deriving acoustic features from linguistic features. The voice dictionary data is created in advance. The linguistic features are features of a language extracted from a text of voice uttered by the utterer. For example, the linguistic features include preceding and following phonemes, information regarding pronunciation, a phrase end position, a sentence length, an accent phrase length, a mora length, a mora position, an accent type, a part of speech, dependency information, and the like. The linguistic features are sometimes called linguistic information. The acoustic features are voice or acoustic features extracted from voice data. As the acoustic features, for example, acoustic features used in hidden Markov model (HMM) voice synthesis may be used. For example, the acoustic features include Mel-frequency cepstral coefficients, Mel-LPC coefficients, and Mel-LSP coefficients, which represent phonological and timbral characteristics, a fundamental frequency (F0), which represents the height of voice, band aperiodicity parameters (BAPs), which represent the ratio of periodic/aperiodic components of voice, and the like. The acoustic features including these coefficients are expressed by a speech waveform represented by a frequency and the like.

In the present embodiment, it is assumed that the storage unit 16 stores in advance a plurality of pieces of voice dictionary data for outputting acoustic features uttered by one or a plurality of utterers with different emotions.

The user sets voice dictionary data used for the type of emotion input in the emotion setting field 40A by operating the input unit 14B while viewing the display screen 30A. Specifically, for example, the user selects voice dictionary data considered to correspond to a corresponding type of emotion from among the plurality of voice dictionary data stored in the storage unit 16 and sets the voice dictionary data in the voice dictionary data setting field 40B by operating the input unit 14B.

In FIG. 2, voice dictionary data of a file name including a type name of a corresponding emotion is illustrated as an example. However, the file name of the voice dictionary data need not include the type name of the corresponding emotion.

It is assumed that voice dictionary data corresponding to the type of emotion “emotionless” is set in advance. The voice dictionary data corresponding to “emotionless” is voice dictionary data for outputting acoustic features of utterances by an utterer without emotion.

In response to these user's input operations, the input receiving unit 20B of the processing unit 20 receives the type of emotion used for setting the voice data and setting of the voice dictionary data corresponding to the type of emotion.

The description will be continued by referring to FIG. 1 again.

The setting unit 20C sets voice dictionary data corresponding to each type of emotion received via the display screen 30A as voice dictionary data used for editing the voice data. For example, the setting unit 20C stores the voice dictionary data corresponding to each type of emotion received via the display screen 30A in a specific storage area of the storage unit 16.

The acquisition unit 20D acquires voice data to be edited. The user designates voice data to be edited stored in the storage unit 16, an external information processing device, or the like by operating the UI unit 14. The acquisition unit 20D acquires, as the voice data to be edited, the voice data designated by the user's operation of the UI unit 14.

In the present embodiment, the input receiving unit 20B receives input of designation of the voice data to be edited via the display screen 30 displayed on the display unit 14A.

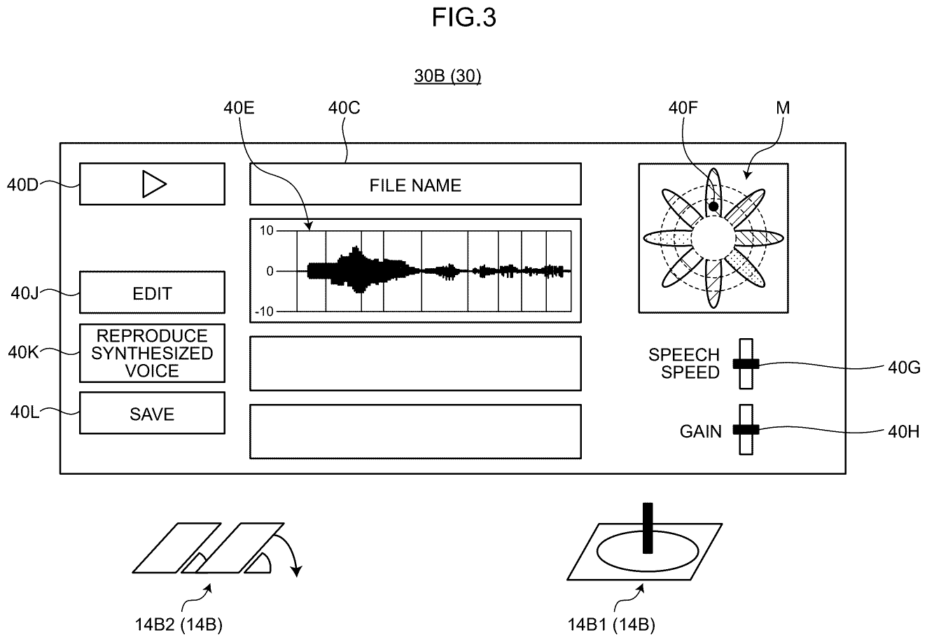

FIG. 3 is a schematic diagram of an example of a display screen 30B. The display screen 30B is an example of the display screen 30. The display screen 30B is a display screen 30B displayed on the UI unit 14 when voice data is designated and parameters are input.

When voice dictionary data is set by a user's operation of the input unit 14B, the display control unit 20A displays the display screen 30B on the display unit 14A.

The display screen 30B includes a voice data file name input display field 40C, a reproduction button 40D, a speech waveform display field 40E, an emotion map M, a pointer 40F, a speech speed adjustment button 40G, a gain adjustment button 40H, an edit button 40J, a synthesized voice reproduction button 40K, and a save button 40L.

The voice data file name input display field 40C is an input and display field for the file name of the voice data to be edited. The user inputs the file name of the voice data to be edited in the voice data file name input display field 40C by operating the input unit 14B while viewing the display screen 30B. The acquisition unit 20D acquires the voice data having the input file name as the voice data to be edited. The user may designate the voice data to be edited stored in the storage unit 16 or the like by operating the input unit 14B while viewing the display screen 30B. In this case, the acquisition unit 20D acquires the designated voice data as the voice data to be edited.

Note that the user may input a file name of text data to be edited by operating the input unit 14B while viewing the display screen 30B. The user may designate the text data to be edited stored in the storage unit 16 or the like by operating the input unit 14B while viewing the display screen 30B.

In this case, the acquisition unit 20D may acquire the voice data to be edited by generating the voice data by a known method using the text data represented by the input file name or the designated text data and voice dictionary data corresponding to the type of emotion “emotionless”.

In the present embodiment, the processing unit 20 of the voice processing support device 10 receives input of a parameter during reproduction of the voice data to be edited.

The parameter is a parameter related to transition of a time-varying emotion used when synthesized voice data is generated from the voice data to be edited. Specifically, the parameter includes at least a plurality of types of emotions different from each other and a mixing ratio of the plurality of types of emotions. The parameter may further include at least one of an emotion intensity, a speech speed, and a sound pressure level. In the present embodiment, an example in which the parameter includes a plurality of types of emotions different from each other, a mixing ratio of the plurality of types of emotions, and an intensity, a speech speed, and a sound pressure level of each of the plurality of emotions will be described.

After designating the voice data to be edited, the user operates the reproduction button 40D for instructing reproduction of the voice data. When the input receiving unit 20B receives a reproduction instruction signal input in response to the operation of the reproduction button 40D, the reproducing unit 20E starts reproducing the voice data. Reproducing voice data means outputting voice represented by the voice data from the voice output unit 14C.

When the reproduction of the voice data is started, the display control unit 20A preferably displays a waveform representing a sound volume of the voice data in the speech waveform display field 40E.

When the reproduction of the voice data is started and the output of the voice of the voice data from the voice output unit 14C is started, the user inputs a parameter for a desired reproduction timing by operating the input unit 14B while viewing the display screen 30B. The reproduction timing means each timing during reproduction of the voice data reproduced along the time axis. That is, the input receiving unit 20B receives input of a parameter at each reproduction timing during reproduction of the voice data to be edited.

Specifically, the user inputs a parameter for a desired reproduction timing during reproduction of the voice data by operating the input unit 14B while gazing at at least one of the pointer 40F on the emotion map M, the speech speed adjustment button 40G, and the gain adjustment button 40H displayed on the display screen 30B.

The emotion map M included in the display screen 30B is similar to the emotion map M described above. The pointer 40F is indicated on the emotion map M. The pointer 40F indicates a point designated by the user on the emotion map M.

For example, the user adjusts the position of the pointer 40F on the emotion map M by operating the first operation unit 14B1, which is a joystick. Specifically, for example, when the inclination direction and the inclination angle of the joystick serving as the first operation unit 14B1 are adjusted, the position of the pointer 40F indicated on the emotion map M displayed on the display screen 30B moves in the inclination direction of the joystick by an amount corresponding to the inclination angle. The user adjusts the position of the pointer 40F displayed on the emotion map M to a position corresponding to a desired type of emotion, a desired mixing ratio of types of emotions, and a desired emotion intensity by operating the first operation unit 14B1. The input receiving unit 20B receives the type of emotion, the mixing ratio of the plurality of types of emotions, and the emotion intensity represented by the position of the pointer 40F on the emotion map M.

The speech speed and the sound pressure level are adjusted by the positions of the speech speed adjustment button 40G and the gain adjustment button 40H included in the display screen 30B. For example, the user adjusts the positions of the speech speed adjustment button 40G and the gain adjustment button 40H on the display screen 30B by operating the pedal-type second operation unit 14B2 by using the user's leg or the like.

For example, the second operation unit 14B2 includes a pedal corresponding to the speech speed adjustment button 40G and a pedal corresponding to the gain adjustment button 40H.

When the user adjusts a depression amount of the pedal of the second operation unit 14B2 corresponding to the speech speed adjustment button 40G, the position of the speech speed adjustment button 40G displayed on the display screen 30B moves in a direction of increasing or decreasing a speech speed. The input receiving unit 20B receives input of a speech speed corresponding to the depression amount of the second operation unit 14B2 corresponding to the speech speed adjustment button 40G.

Similarly, when the user adjusts a depression amount of the pedal of the second operation unit 14B2 corresponding to the gain adjustment button 40H, the position of the gain adjustment button 40H displayed on the display screen 30B moves in a direction of increasing or decreasing a sound pressure (gain). The input receiving unit 20B receives input of a sound pressure corresponding to the depression amount of the second operation unit 14B2 corresponding to the gain adjustment button 40H.

As described above, by operating at least one of the first operation unit 14B1 and the second operation unit 14B2 at each desired reproduction timing during reproduction of the voice data, the user inputs a parameter including at least one of a desired type of emotion, mixing ratio of a plurality of types of emotions, emotion intensity, speech speed, and sound pressure level for the reproduction timing. Furthermore, the input receiving unit 20B receives input of a parameter at each reproduction timing during reproduction of the voice data.

The description will be continued by referring to FIG. 1 again.

The recording unit 20F records the input parameter in association with the reproduction timing of the voice data for which the input of the parameter has been received. Specifically, for example, the recording unit 20F stores the input parameter and a time stamp indicating the reproduction timing of the voice data for which the input of the parameter has been received in association with each other. Note that the recording unit 20F may record the input parameter in association with a position corresponding to the reproduction timing of the voice data for which the input of the parameter has been received.

The reproducing unit 20E generates, for the voice data to be edited, synthesized voice data based on voice dictionary data corresponding to an emotion corresponding to the parameter associated with each reproduction timing.

Specifically, the reproducing unit 20E obtains acoustic features corresponding to each type of emotion by inputting linguistic features (linguistic information) at a reproduction timing of the voice data to be edited to the voice dictionary data corresponding to each of the plurality of types of emotions included in the parameter set at the reproduction timing. Then, the reproducing unit 20E obtains first mixed acoustic features by mixing the obtained acoustic features corresponding to the types of emotions in accordance with the mixing ratio of the emotions included in the parameter set at the reproduction timing. Furthermore, the reproducing unit 20E obtains second acoustic features corresponding to “emotionless” by inputting the linguistic features at the reproduction timing of the voice data to be edited to voice dictionary data corresponding to “emotionless”. Then, the reproducing unit 20E obtains second mixed acoustic features by mixing the second acoustic features corresponding to “emotionless” and the first mixed acoustic features at a ratio according to the emotion intensity included in the parameter set at the reproduction timing. Specifically, the reproducing unit 20E obtains the second mixed acoustic features by increasing the ratio of the second acoustic features corresponding to “emotionless” as the emotion intensity decreases and increasing the ratio of the first mixed acoustic features as the emotion intensity increases.

Then, the reproducing unit 20E generates, as synthesized voice data at the reproduction timing, synthesized voice having a speech waveform represented by the second mixed acoustic features.

The reproducing unit 20E generates, for each of a plurality of reproduction timings along the time axis included in the voice data, synthesized voice by the above processing using a parameter set at the reproduction timing, and thereby generates synthesized voice data in which the voice data is synthesized in accordance with the parameter.

Then, the recording unit 20F records the parameter used to generate the synthesized voice at each reproduction timing of the generated synthesized voice data in association with the reproduction timing.

When the synthesized voice reproduction button 40K on the display screen 30B is operated by a user's operation of the input unit 14B, the reproducing unit 20E reproduces the synthesized voice data. The reproducing unit 20E reproduces the synthesized voice data by outputting the generated synthesized voice data to the voice output unit 14C. Note that the reproducing unit 20E may generate and reproduce the synthesized voice data when the synthesized voice reproduction button 40K is operated by a user's operation of the input unit 14B.

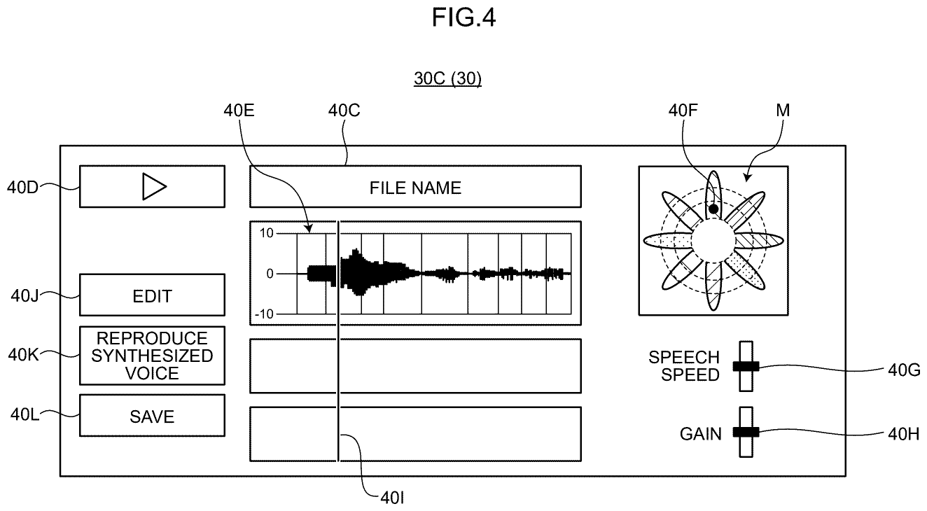

FIG. 4 is a schematic diagram of an example of a display screen 30C. The display screen 30C is an example of the display screen 30. The display screen 30C is a display screen 30 displayed on the display unit 14A when the synthesized voice data is reproduced. The display control unit 20A displays the display screen 30C on the display unit 14A when the synthesized voice reproduction button 40K is operated by a user's operation of the input unit 14B.

The display screen 30C includes a reproduction timing image 40I in addition to the display screen 30B. The reproduction timing image 40I is an image representing a current reproduction timing in the waveform representing the synthesized voice data displayed in the speech waveform display field 40E. Accordingly, the display control unit 20A moves a display position of the reproduction timing image 40I to a position corresponding to the current reproduction timing in the waveform representing the synthesized voice data with passage of time as the synthesized voice data is reproduced.

Furthermore, the display control unit 20A preferably adjusts the positions of the pointer 40F, the speech speed adjustment button 40G, and the gain adjustment button 40H on the display screen 30C to display positions corresponding to the parameter set at each reproduction timing of the synthesized voice data.

As described above, the recording unit 20F records the parameter used to generate synthesized voice at each reproduction timing of the synthesized voice data in association with the reproduction timing. During reproduction of the synthesized voice data, the display control unit 20A displays the pointer 40F at a position representing the type of emotion, the mixing ratio, and the emotion intensity represented by the parameter recorded in association with the current reproduction timing on the emotion map M. Furthermore, during reproduction of the synthesized voice data, the display control unit 20A displays the speech speed adjustment button 40G and the gain adjustment button 40H at positions representing the speech speed and the gain represented by the parameter recorded in association with the current reproduction timing.

The user may wish to edit the parameter. In this case, the user operates the edit button 40J on the display screen 30B by operating the input unit 14B. When the edit button 40J is operated, the input receiving unit 20B starts receiving parameter editing. As described above, the input unit 14B is a pointing device such as a digital pen, a mouse, or a trackball, or an input device such as a keyboard. Furthermore, the input unit 14B may include the first operation unit 14B1 such as a joystick and the second operation unit 14B2 such as a pedal. Therefore, user's input of a parameter is not limited to the first operation unit 14B1 such as a joystick and the second operation unit 14B2 such as a pedal, and a parameter may be input by simultaneously operating one or more of pointing devices such as a mouse, a digital pen, and a drag ball, a keyboard, and the like.

Specifically, the user selects an edit point to be edited in the waveform representing the voice data displayed in the speech waveform display field 40E included in the display screen 30B by operating the input unit 14B. Then, the user edits a parameter associated with the edit point by operating the input unit 14B while gazing at at least one of the pointer 40F on the emotion map M, the speech speed adjustment button 40G, and the gain adjustment button 40H displayed on the display screen 30B. An operation for editing the parameter is similar to the operation for inputting a parameter for the voice data.

That is, the user edits at least one parameter among desired type of emotion, mixing ratio of a plurality of types of emotions, emotion intensity, speech speed, and sound pressure level for the selected edit point by operating at least one of the first operation unit 14B1 and the second operation unit 14B2. Furthermore, the input receiving unit 20B receives input of the parameter editing at the selected edit point.

The recording unit 20F records the edited parameter in association with the selected edit point in the synthesized voice data. Specifically, for example, the recording unit 20F stores the edited parameter and a time stamp indicating the selected edit point in the synthesized voice data in association with each other. Note that the recording unit 20F may record the edited parameter in association with a position corresponding to the selected edit point in the synthesized voice data.

Then, the reproducing unit 20E reproduces the synthesized voice data in accordance with the edited parameter. The reproducing unit 20E may generate the synthesized voice data in accordance with the edited parameter in a similar manner to the generation of the synthesized voice data based on the voice data for which a parameter has been set. The recording unit 20F records the regenerated synthesized voice data and the parameter set at each reproduction timing in association with each other.

When the input of the parameter is finished, the user operates the save button 40L. The save button 40L is a button operated by the user when the user instructs the storage unit 16 to store the synthesized voice data generated from the voice data for which a parameter has been set. When the save button 40L is operated, the input receiving unit 20B receives a save instruction.

When the input receiving unit 20B receives the save instruction, the display control unit 20A displays, on the display unit 14A, a display screen 30 for receiving input of character information for the synthesized voice data.

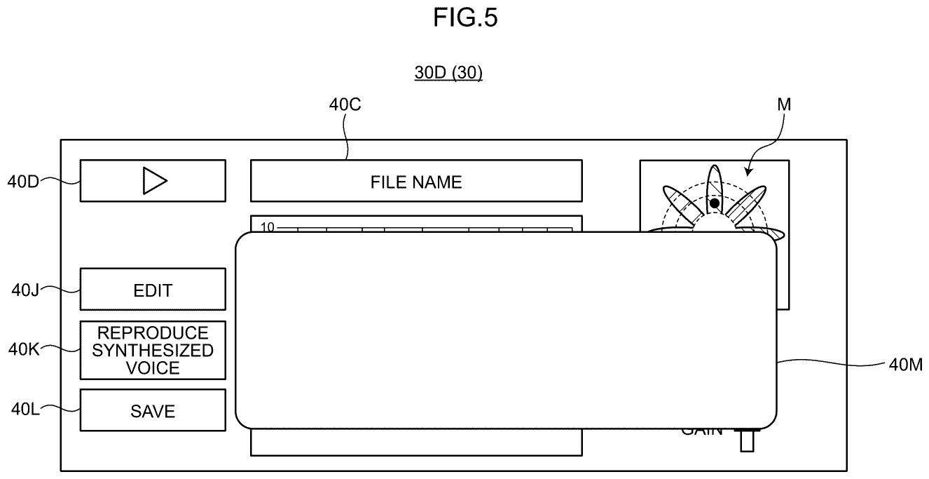

FIG. 5 is a schematic diagram of an example of a display screen 30D. The display screen 30D is an example of the display screen 30. The display screen 30D is a display screen 30 displayed when the save button 40L is operated by the user.

When the save button 40L is operated by a user's operation of the input unit 14B, the display control unit 20A displays, on the display unit 14A, a display screen 30D in which a character information input field 40M is superimposed on the display screen 30C. The character information input field 40M is an input field for character information to be added to the synthesized voice data. For example, the user inputs character information such as an explanation for the synthesized voice data in the character information input field 40M by operating the input unit 14B.

The input receiving unit 20B receives the character information for the synthesized voice data via the character information input field 40M. The recording unit 20F stores the input character information in the storage unit 16 in association with the synthesized voice data.

Through these processes, document information indicating the explanation regarding synthesized voice data is stored in association with the synthesized voice data. Therefore, a user or the like of the synthesized voice data can effectively reuse the synthesized voice data by checking the character information. Furthermore, by using the synthesized voice data and the character information added to the synthesized voice data as training data, it is possible to generate a learning model for outputting character information as a correct answer label from synthesized voice data.

Next, an example of a flow of information processing executed by the voice processing support device 10 according to the present embodiment will be described.

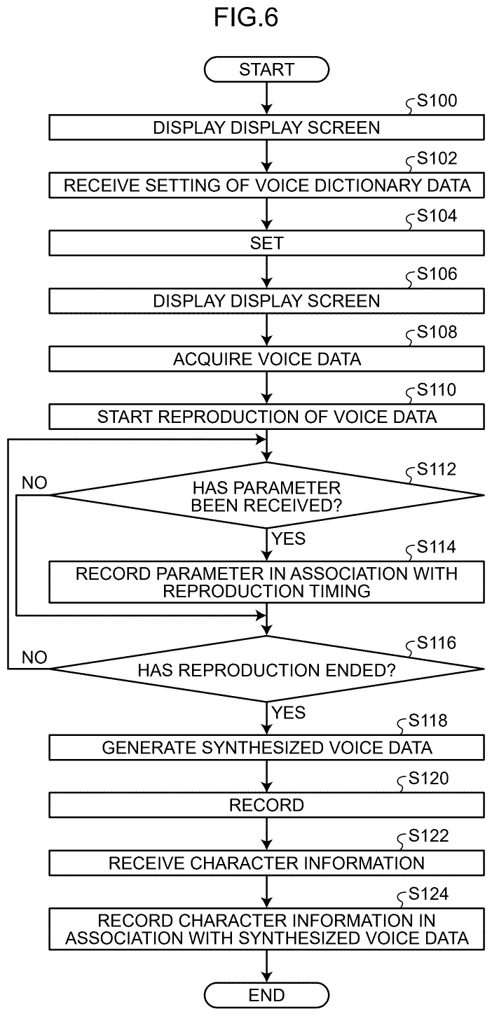

FIG. 6 is a flowchart illustrating an example of a flow of information processing executed by the voice processing support device 10 according to the present embodiment.

The display control unit 20A displays the display screen 30A on the display unit 14A (step S100). For example, when a signal indicating the start of editing of voice data is input by a user's operation or the like of the input unit 14B, the display control unit 20A displays the display screen 30A for receiving a type of emotion and setting of voice dictionary data on the display unit 14A.

The user sets a type of emotion used for setting voice data and voice dictionary data used for the type of emotion by operating the input unit 14B while viewing the display screen 30A. The input receiving unit 20B receives the type of emotion used for setting the voice data and setting of the voice dictionary data corresponding to the type of emotion (step S102).

The setting unit 20C sets the voice dictionary data corresponding to each type of emotion received via the display screen 30A as voice dictionary data used for editing the voice data (step S104).

The display control unit 20A displays the display screen 30B for receiving setting of a parameter for the voice data on the display unit 14A (step S106). The display screen 30B illustrated in FIG. 4 is displayed by the process in step S106.

The user inputs the file name of the voice data to be edited in the voice data file name input display field 40C by operating the input unit 14B while viewing the display screen 30B. The acquisition unit 20D acquires the voice data having the input file name as the voice data to be edited (step S108).

The user operates the reproduction button 40D for instructing reproduction of the voice data. When the input receiving unit 20B receives a reproduction instruction signal input in response to the operation of the reproduction button 40D, the reproducing unit 20E starts reproducing the voice data acquired in step S108 (step S110).

When reproduction of the voice data is started, the user inputs a parameter for a desired reproduction timing during reproduction of the voice data by simultaneously operating the first operation unit 14B1 such as a joystick, the second operation unit 14B2 such as a pedal type, the input unit 14B such as a mouse, and the like while gazing at at least one of the pointer 40F on the emotion map M, the speech speed adjustment button 40G, and the gain adjustment button 40H displayed on the display screen 30B while listening to the reproduced voice. That is, the user collectively inputs parameters such as a desired type of emotion, mixing ratio of a plurality of types of emotions, emotion intensity, speech speed, and sound pressure level for a desired reproduction timing while listening to the reproduced voice. In response to the user's operation during the reproduction of the voice data, the parameters including the desired type of emotion, mixing ratio of the plurality of types of emotions, emotion intensity, speech speed, sound pressure level, and the like are collectively input for each reproduction timing of the voice data.

During the reproduction of the voice data, the input receiving unit 20B determines whether input of a parameter has been received from the input unit 14B (step S112). In a case where a negative determination is made in step S112 (step S112: No), the process proceeds to step S116, which will be described later. In a case where a positive determination is made in step S112 (step S112: Yes), the process proceeds to step S114.

In step S114, the recording unit 20F records the parameter received in step S112 in association with the reproduction timing of the voice data for which the input of the parameter has been received (step S114).

Next, the reproducing unit 20E determines whether or not the reproduction of the voice data has ended (step S116). For example, the reproducing unit 20E makes the determination in step S116 by determining whether or not the reproduction has ended up to the final timing on the time axis of the voice data whose reproduction started in step S110. In a case where a negative determination is made in step S116, the process returns to step S112. In a case where a positive determination is made in step S116 (step S116: Yes), the process proceeds to step S118.

The reproducing unit 20E generates, for the voice data acquired in step S108, synthesized voice data by synthesizing voice dictionary data corresponding to the emotions corresponding to the parameters associated with the reproduction timings (step S118).

The recording unit 20F records the parameter used to generate synthesized voice at each reproduction timing of the generated synthesized voice data in association with the reproduction timing (step S120).

Note that the user can also set or edit a parameter for each reproduction timing again while listening to the synthesized voice data. Furthermore, as described above, the processing unit 20 may receive selection of an edit point in the waveform of the synthesized voice data displayed on the display screen 30B, receive editing of a parameter at the edit point, and records the edited parameter in association with a position corresponding to the selected edit point in the synthesized voice data.

The display control unit 20A displays the display screen 30D on which the character information input field 40M is superimposed. The input receiving unit 20B receives character information input in the character information input field 40M in response to a user's operation of the input unit 14B (step S122).

The recording unit 20F records the character information received in step S138 in association with the synthesized voice data generated in step S132 (step S124). Then, this routine is ended.

As described above, the voice processing support device 10 according to the present embodiment includes the input receiving unit 20B and the recording unit 20F. The input receiving unit 20B receives input of a parameter including at least a plurality of types of emotions different from each other and a mixing ratio of the plurality of types of emotions during reproduction of voice data to be edited. The recording unit 20F records the input parameter in association with the reproduction timing of the voice data for which the input of the parameter has been received.

According to the related art, it is difficult to set a parameter related to transition of a time-varying emotion in detail although it is possible to set a parameter such as a morphing ratio for the entire voice data.

On the other hand, the voice processing support device 10 according to the present embodiment receives input of a parameter including at least a plurality of types of emotions different from each other and a mixing ratio of the plurality of types of emotions during reproduction of voice data to be edited. Then, the voice processing support device 10 records the input parameter in association with a reproduction timing of the voice data for which the input of the parameter has been received.

Therefore, the voice processing support device 10 according to the present embodiment can set a parameter including at least the types of emotions and the mixing ratio of the emotions for each reproduction timing along the time axis of the voice data.

Therefore, the voice processing support device 10 according to the present embodiment can set a parameter related to transition of a time-varying emotion in detail.

In addition, the voice processing support device 10 according to the present embodiment can set, for voice data, a parameter that enables dynamic voice expression in which an emotion and the intensity of the emotion change on the time axis.

In addition, since the voice processing support device 10 according to the present embodiment receives input of a parameter at each reproduction timing during reproduction of voice data, it is possible to set a parameter for each reproduction timing in real time simultaneously with the reproduction of the voice data.

Furthermore, according to the voice processing support device 10 according to the present embodiment, the user can set a parameter for each reproduction timing by operating the input unit 14B. Therefore, the voice processing support device 10 according to the present embodiment can lessen load of user's input and editing and enable detailed setting of a time-varying parameter.

Next, a hardware configuration of the voice processing support device 10 according to the present embodiment will be described.

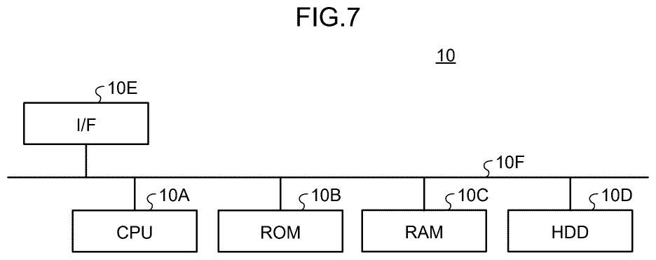

FIG. 7 is a hardware configuration diagram of an example of the voice processing support device 10 according to the present embodiment.

The voice processing support device 10 according to the present embodiment includes a control device such as a CPU 10A, a storage device such as a read only memory (ROM) 10B or a random access memory (RAM) 10C, a hard disk drive (HDD) 10D, an I/F 10E that is connected to a network and performs communication, and a bus 10F that connects the units.

A program executed by the voice processing support device 10 according to the present embodiment is provided by being incorporated in the ROM 10B or the like in advance.

The program executed by the voice processing support device 10 according to the present embodiment may be provided as a computer program product by being recorded as a file in an installable format or an executable format in a computer-readable recording medium such as a compact disk read only memory (CD-ROM), a flexible disk (FD), a compact disk recordable (CD-R), or a digital versatile disc (DVD).

The program executed by the voice processing support device 10 according to the present embodiment may be stored on a computer connected to a network such as the Internet and provided by being downloaded via the network. The program executed by the voice processing support device 10 according to the present embodiment may be provided or distributed via a network such as the Internet.

The program executed by the voice processing support device 10 according to the present embodiment can cause a computer to function as each unit of the voice processing support device 10 described above. In this computer, the CPU 10A can read a program from a computer-readable storage medium onto a main storage device and execute the program.

Note that the above embodiment has been described assuming that the voice processing support device 10 is configured as a single device. However, the voice processing support device 10 may include a plurality of devices that are physically separated and communicably connected via a network or the like.

The voice processing support device 10 according to the above embodiment may be provided as a virtual machine that operates on a cloud system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A voice processing support device comprising
one or more hardware processors configured to:
receive input of a parameter during reproduction of voice data to be edited, the parameter including at least a plurality of types of emotions different from each other and a mixing ratio of the plurality of types of emotions; and
record the parameter whose input has been received, in association with a reproduction timing at which the input of the parameter has been received in the voice data.

2. The device according to claim 1, wherein
the parameter further includes at least one of an emotion intensity, a speech speed, and a sound pressure level.

3. The device according to claim 1, wherein
the one or more hardware processors are further configured to display a display screen including an emotion map indicating a correlation among a plurality of types of emotions, and
the one or more hardware processors are configured to receive, as the parameter, at least one of: the types of emotions; the mixing ratio; and an emotion intensity corresponding to a point on the emotion map designated by a user.

4. The device according to claim 1, wherein
the one or more hardware processors are configure to receive setting of voice dictionary data corresponding to a type of emotion used for setting for voice data.

5. The device according to claim 1, wherein
the one or more hardware processors are further configured to reproduce, for the voice data, synthesized voice data based on voice dictionary data corresponding to the types of emotions corresponding to the parameter associated with each reproduction timing.

6. The device according to claim 5, wherein
the one or more hardware processors are configured to:
receive editing of the parameter; and
store the parameter whose editing has been received, in association with an edit point selected in the synthesized voice data.

7. The device according to claim 5, wherein
the one or more hardware processors are configured to:
receive input of character information for the synthesized voice data; and
record the character information in association with the synthesized voice data.

8. A voice processing support method executed by a voice processing support device, the voice processing support method comprising:
receiving input of a parameter during reproduction of voice data to be edited, the parameter including at least a plurality of types of emotions different from each other and a mixing ratio of the plurality of types of emotions; and
recording the parameter whose input has been received, in association with a reproduction timing at which the input of the parameter has been received in the voice data.

9. A computer program product comprising a non-transitory computer-readable medium including programmed instructions, the instructions causing a computer to execute:
receiving input of a parameter during reproduction of voice data to be edited, the parameter including at least a plurality of types of emotions different from each other and a mixing ratio of the plurality of types of emotions; and
recording the parameter whose input has been received, in association with a reproduction timing at which the input of the parameter has been received in the voice data.
